(19) United States
(12) Patent Application Publication
(10) Pub. No.: US 2025/0116074 A1
(43) Pub. Date: Apr. 10, 2025

(54) GROUND PROTECTION MAT AND METHOD OF USE

(71) Applicant: Wearwell, LLC, Smyrna, TN (US)

(72) Inventor: Philip C. Huss, Smyrna, TN (US)

(21) Appl. No.: 18/905,635

(22) Filed: Oct. 3, 2024

Related U.S. Application Data
(60) Provisional application No. 63/542,322, filed on Oct. 4, 2023.

(51) Int. Cl. E01C 9/08; C08F 110/06; C08F 218/08; E01C 5/20

(52) U.S. Cl. CPC E01C 9/086; C08F 110/06; C08F 218/08; E01C 5/20

(57) ABSTRACT

A ground protection mat is in the form of a sheet material that is made from foamed polymeric material, preferably a foamed polypropylene or foamed ethylene vinyl acetate, and more preferably a material having a flexural strength ranging from about 2400 to about 6000 kpa. The sheet material can include raised portions on a top side thereof, or both top and bottom sides to improve traction for people or equipment traveling over the ground protection mats. The ground protection mats are light weight so that one individual can easily carry one, or even two, to be positioned in a desired location, but provide the necessary stiffness and strength for transportation and use purposes.

### FIELD OF THE INVENTION

A ground protection mat that is designed to cover ground and prevent damage thereto by the use of heavy equipment is designed with a lightweight foamed polymeric material like a foamed polypropylene or foamed ethylene vinyl acetate. The mat is designed in various lengths and widths, preferably 4×8 foot sheets, to accommodate large types of heavy equipment.

### BACKGROUND OF THE INVENTION

Ground protection mats are known for use to prevent damage to ground surfaces when heavy equipment is to be used. One example of such a mat is made by Blue Gator, based in Ocala, Florida. The website for this product is www.bluegatorpro.com.

FIG. 1 is an example of how these mats are used to protect a golf course ground when heavy equipment is needed to be used.

These mats are made from high density polyethylene (HDPE) which is infused with rubber for better traction and are designated by 50 in FIG. 1. The heavy equipment as a front end loader 51 is shown with its tires positioned over the mats 50.

The mats are made with slots along the sides to facilitate carrying the mats. FIG. 2A shows two people carrying the mats to be placed in a given location with FIG. 2B showing a section of the mat with a carrying slot 52 therein. The mats also have openings in the corners to facilitate securing the mats in a given location using, for example, stakes or other fastening means. The mats are typically about ½ inch in thickness. The mats are also made with raised portions extending from a top surface of the mat for traction purposes.

One major problem with these mats is that since they are high density polyethylene, they are heavy, roughly eighty pounds per 4×8 foot mat, and two people are required to lay the mats in a desired location, see FIG. 2A. FIG. 2A also shows that the mats must have sufficient stiffness to facilitate their movement to and from a given location. The stiffness also contributes to the stability of the mat once placed on the ground to receive loads from heavy equipment.

Thus, a need exists to develop an alternative mat that provides the necessary stiffness properties but avoids the excessive weight problem when transporting the mat. The present invention responds to this need and provides an improved ground protection mat and method of use.

### SUMMARY OF THE INVENTION

One object of the invention is to provide an improved ground protection mat, wherein the ground protection mat is easily transported and positioned in a desired location.

Another object of the invention is a method of using a ground protection mat, wherein the mat is lightweight in nature and one or even two mats can be carried by a single person to a desired location for placement.

In one embodiment, the ground protection mat comprises a sheet of material, the sheet of material having side edges and end edges, the sheet of material made from a foamed polymeric material, preferably a foamed polypropylene or a foamed ethylene vinyl acetate, the sheet material having at least a 0.75 inch thickness, the sheet material including means for attaching the sheet material to ground for ground protection purposes. Preferably, the sheet material has a flexural strength of 2500-6000 kpa, preferably 3000-5000 kpa, more preferably and it is believed that any polymeric foam material that has this flexural strength range would be a candidate for the ground protection mat.

The ground protection mat has top and bottom surfaces, and one or both of the top and bottom surfaces can include a plurality of raised portions extending from the top and/or bottom surface to provide traction for any equipment contacting the ground protection mat.

The ground protection mat can also include a plurality of mat-carrying slots, the plurality of mat-carrying slots arranged near either or both of the side and/or end edges. Preferably, the sheet of material is the foamed ethylene vinyl acetate and the sheet of material can have a density ranging between about 33 to 280 kg/m³. The sheet of material could also be a foamed polypropylene with a density ranging between about 140 and 220 kg/m³.

While the mat can have any size, a preferred size range is from 2 to 6 feet in width and 6-9 feet in length, preferably 8 feet in length.

While the attaching means can be any kind of mechanical arrangement that would hold the ground protection mat in place, one example of such means includes through openings in the mat in spaced apart locations, preferable the spaced apart locations being near corners of the mat.

The ground protection mat can also include means for connecting or attaching opposing ends of adjacent mats together, for example, a hinged connection so that the mats could be folded on top of each other for storage and/or transport.

Another aspect of the invention is the use of the ground protecting mats to protect ground from damage due to undue weight placed thereon by heavy equipment or the like. The method first includes the step of providing a plurality of inventive ground protection mats. The ground protection mats are then placed on the ground in a desired arrangement to protect the ground from damage. The placing step can also include a step of attaching the mats to ground using the attaching means. However, in certain circumstances, the mats may be placed on the ground without attachment thereto.

While the mats can be placed on ground in any arrangement, a preferable arrangement is wherein the mats are placed end to end to create at least one track for ground protection, and preferably a placement wherein two tracks of end to end mats are created. The two tracks can then provide protection for heavy duty equipment such as front end loaders, bulldozers, and the like.

The method of use of the ground protection mats also includes the step of driving heavy equipment on the plurality of mats.

Another aspect of the inventive method is the ability to easily transport the mats, wherein one or two mats can be transported without the use of some carrying means or two people.

Given the foam nature of the ground protection mats, the mats can come in a folded state and be unfolded for transport.

### BRIEF DESCRIPTION OF THE DRAWINGS

FIG. 1 shows a prior art ground protection mat in use.

FIG. 2A shows a prior art ground protection mat in transport.

FIG. 2B shows a portion of the mat of FIG. 2a with a slot therein.

FIG. 3 shows a top perspective view of the inventive ground protection mat.

FIG. 4 shows a bottom perspective view of the inventive ground protection mat.

FIG. 5 shows an enlarged bottom perspective view of the inventive ground protection mat.

FIGS. 6A-6C illustrate different means for attaching the mats to ground.

FIG. 7 shows a segment of a pair of ground protection mats with a hinged connection therebetween.

### DETAILED DESCRIPTION OF THE INVENTION

The inventive ground protection mat provides a significant improvement in these types of mats in terms of providing a lightweight mat that is easily positioned in a desired location and one that has the necessary properties, e.g., density and stiffness to function as a ground protection mat.

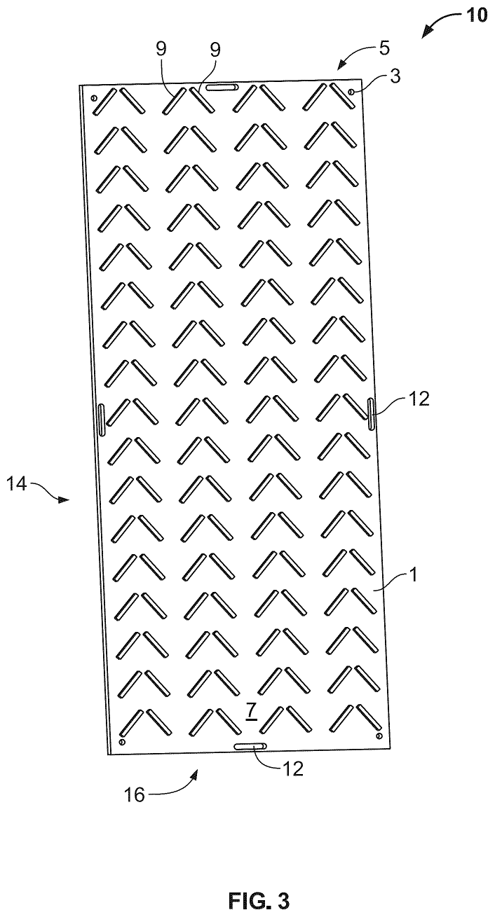

FIG. 3 shows a top perspective view of an exemplary ground protection mat, which is designated by the reference numeral 10 with its top side designated by the reference numeral 1. While the mat can have any size, it is shown with a rectangular configuration. The mat is shown with through openings 3 in corner portions 5. The openings 3 are designed to receive a stake or other peg-like member that would retain the mat in a desired space. The mat top surface 7 is shown with raised portions 9 for traction purposes. The raised portions 9 are arranged to form a v-shape that extends both longitudinally and transversely along the mat top surface 7. It should be understood that the raised portions are only one example of a traction-providing raised portion and other shapes or designs could be used as part of the top surface. The extent of the raising from the surface can also vary with an example of a protrusion height being about 0.3 inches.

The mat 10 can also include carrying slots 12, which are positioned at the midpoint of each side 14 and midpoint of each end 16. These carrying slots provide an opening for a hand or other gripping member to hold the mat for transport.

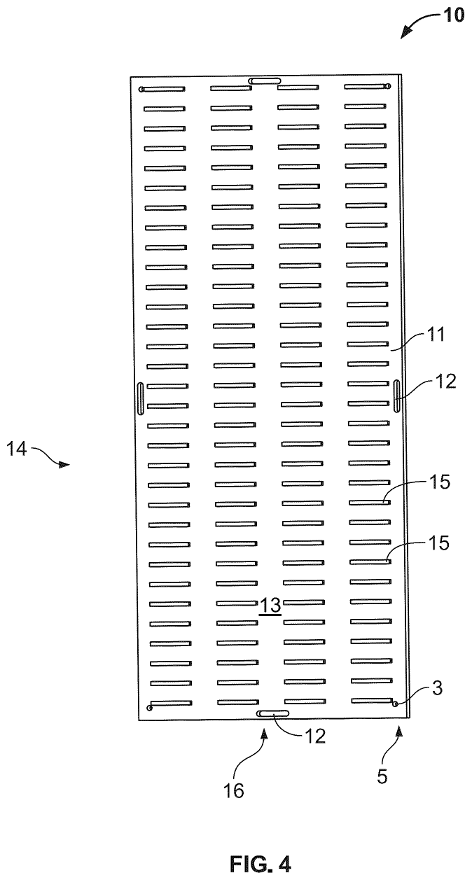

FIG. 4 shows the underside or bottom of the mat 11. In this embodiment, the underside 11 also includes a surface 13 with raised portions 15 extending therefrom. The raised portions 13 are rectangular in shape and also extend longitudinally and transversely on the surface 11. Certain conditions may prefer the use of the raised portions 9, wherein two adjacent raised portions are arranged to form a v-shape and other conditions may prefer the use of the raised portions 13. For example, if the mat 10 is on a slope, it may be preferred to use the side 1 with the raised portions 9 forming v-shapes, with the point of the v directed downhill to better channel rain water or the like. Having the different kinds of protrusions on either surface of the mat provides more flexibility in using the mat in certain conditions. The height of the protrusions can differ for each side, with the v-shaped protrusions being larger in one embodiment, about 0.3 inches as opposed the other protrusions, which could have a height of about 0.2 inches.

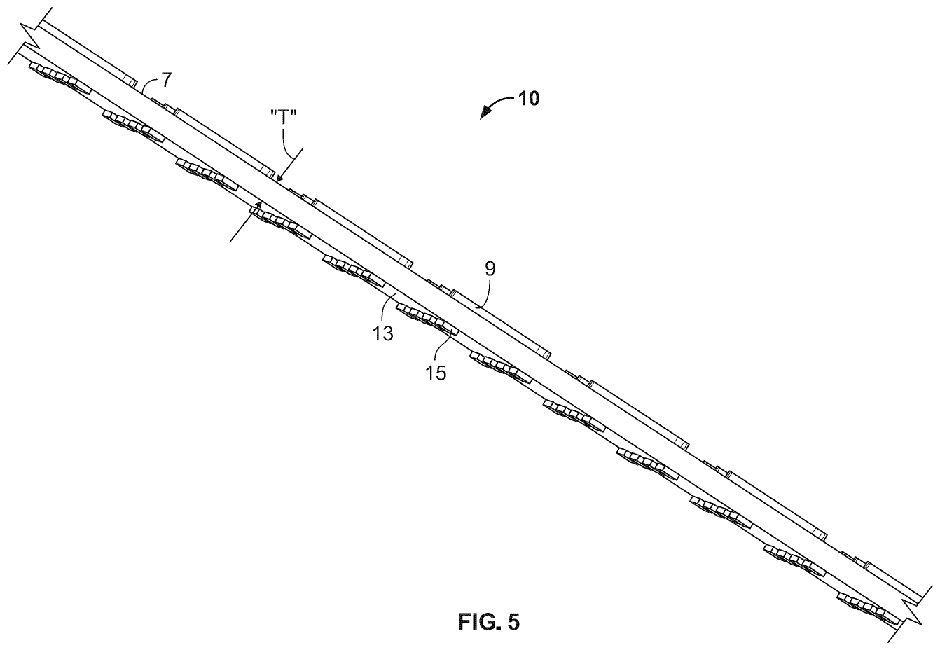

FIG. 5 shows another and enlarged view of the mat to show greater detail for the raised portions on the top side 1 and underside 11, with “T” representing a thickness of the mat without taking into consideration the raised portions 9 or 13.

The lightweight feature of the mat is attributed to its composition being a foamed polymeric material such as foamed polypropylene or foamed ethylene vinyl acetate. Foamed polypropylene is a well known material that is known to be made into various shapes. However, for use as a ground protection mat, the foamed polypropylene must have sufficient stiffness so that it can properly function as a ground protection mat. Similarly, foamed ethylene vinyl acetate is a well known material that is ideal for use as the inventive ground protection mat.

The table below shows properties of a commercially available foamed polypropylene. It is believed that the foams under the kinds that would fall on or between the designations for H140 and H220 would work effectively as a ground protection. As can be seen from the table, the thickness of this foam is 19 mm or roughly 0.75 inches. A 4×8 foot size mat of this kind of foam would only weigh about 24 pounds, which is less than one third of the weight of the prior art ground protection mats. Thus, for a mat that is only slightly thicker, i.e., 0.75 inches versus the 0.5 inch thickness of the prior art HDPE rubber infused ground protection mats, a similar kind of stiffness is obtained for use in moving and placing of the mats, but, at the same time, providing a mat that can be moved easily by one person. In the alternative, three mats at 72 pounds could be moved at the same time as one eighty pound prior art mat using the same two persons, thus increasing the efficiency of positioning the mats for use. It should be understood that the thickness should be at least 0.75 inches. While thicker mats could be employed, e.g., the H140 at an inch or 25 mm thickness from the table above, the properties are not as desirable, particularly in terms of flexural strength.

While it is known that foamed polymeric materials like PP foam and EVA foam are not as strong as HDPE, the increased thickness of the sheet of material makes up for the difference in strength between polymeric foam sheet materials like PP foam or EVA foam and HDPE sheet material of the same thickness. The stiffness of the inventive ground protection mats, while facilitating their transport also provides resistance to the ground protection mats sinking into the ground when heavy equipment travels over the mats.

### Physical Properties—Foam Only

| | Test | | H140 | H220 | H80 | H140 | H220 | H140 |
|---|---|---|---|---|---|---|---|---|
| Properties | Method | Units | 14 mm | 14 mm | 19 mm | 19 mm | 19 mm | 25 mm |
| Density | ISO 845 | Kg/m³ | 140 | 220 | 80 | 140 | 220 | 140 |
| Compression | ASTM | kPa | 1383 | 2299 | 272 | 1250 | 3584 | 1391 |
| Strength @ | D695 | | | | | | | |
| 25% | | | | | | | | |
| Compression | ISO 1922 | kPa | 21750 | 33000 | 4200 | 18000 | 58250 | 24200 |
| modulus | | | | | | | | |
| Flexural | ASTM | kPa | 2335 | 3172 | 1475 | 2459 | 3430 | 1876 |
| strength @ | D1037 | | | | | | | |
| 24° C. | | | | | | | | |
| Screw | ASTM | N | 269 | 504 | 135 | 420 | 930 | 546 |
| Retention | D1037 | | | | | | | |
| #10 Screw | | | | | | | | |
| Nail | ASTM | N | 30 | 51 | 11 | 45 | 121 | 60 |
| Retention | D1037 | | | | | | | |
| Flammability | FMVSS | Pass | Pass | Pass | Pass | Pass | Pass | Pass |
| | 302 | or Fail | | | | | | |
| Thermal | ASTM | W/mK | 0.045 | 0.051 | 0.043 | 0.046 | 0.058 | 0.051 |
| Conductivity | D5930 | | | | | | | |
| @ 24° C. | | | | | | | | |
| R-Value | ASTM | Per | 3.4 | 2.8 | 2.4 | 3.2 | 2.5 | 2.8 |
| | D2844 | Inch | | | | | | |
| Water | ASTM | Kg/m³ | 0.51 | 0.17 | .29 | 0.18 | 0.09 | 0.32 |
| Absorption | D3575 | | | | | | | |

It should also be understood that the thickness of at least 0.75 inches is needed to provide the sufficient stiffness for the mat, this thickness is the thickness as measured at the side edge of the mat. The overall thickness of the mat would be greater if protrusions are used.

If an ethylene vinyl acetate foam is employed for the ground protection mat, a higher density foam is preferred as the higher density EVA foams are stiffer in nature and more easily handled for placement purposes. The EVA foams are also preferred over foams like PP foams as these types of foams are more shear and crack resistant as compared to PP foam.

While the density of an EVA foam can vary from 33 to 280 kg/m³, it is known that EVA foam is much lighter than PP foam. This means that the EVA foam for a given thickness would be denser than a PP foam. Thus, it is preferable to use flexural strength as a measure for the foam polymeric material property for selection as a ground protection mat as this measure would be similar between different polymeric foams, including EVA foams and PP foams as well as other known polymeric foams. The flexural strength would range between about 2400-6000 kpa, with a preferred range of about 3000-5000 kpa.

Besides the comparable stiffness that the inventive mat provides, it is also believed that the mat has the necessary strength to retain its integrity even when placed under loads that heavy equipment would place on the mats. The inventive mat is believed to offer the same kinds of strength as the HDPE mats of the prior art in terms of handing large forces due to the weight of heavy equipment.

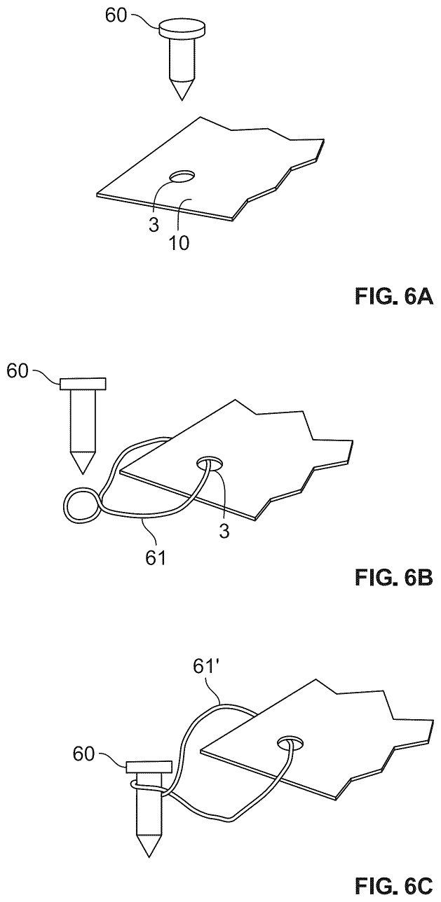

The openings in the mat corners are preferred to keep the mats in place once located. However, openings could be located along the side edges of the mat or locations more central is so desired. In fact, any means for fastening the mat to ground can be employed in combination with the mat itself. Through openings located in corners and/or along the edges could be examples of one means, with these openings sized to receive head-containing stakes or pegs that penetrate the ground with the head contacting the mat surface to hold the mat in place. Other means could include rope or the like that would be attached through the through openings, the rope configured to attach to a stake or peg spaced from the mat. The rope could have a stake or peg integrated therewith so that the stake or pegs accompany the mat for attachment to a ground surface. FIGS. 6A-6C show examples of different means of attaching the mat to a ground surface. In FIG. 6A, the opening 3 is shown to receive a stake 60. FIG. 6B shows a rope 61 that loops through the opening 3 and has another loop to receive the stake 69. FIG. 6C shows a rope 61′ similar to rope 60, but is one that is attached at 63 to the stake 60 using any known way of attachment so that the rope and stake stay with the mat for attachment purposes. Although not illustrated, a stake could be attached to the mat in a different way, e.g., held by a fastener on the side edge of the mat, e.g., a hook and loop fastener so that the stake would be part of the mat for attachment purpose. This would function like a means to retain the stake with the mat so that it can be used with the through openings for attachment purposes.

The mat can be made in any conventional way that sheets of foamed polymeric material such as foamed polypropylene or foamed ethylene vinyl acetate are made. If molding is used, the raised portions would be made as part of the molding operation.

With the lightweight nature of the mat, the slots used in the prior art mats could be eliminated as the mat could easily be carried by one person. However, the slots along the periphery of the mat could be employed if so desired as shown in FIGS. 3 and 4. With the use of the slots such as shown in FIG. 2B, two people could carry two or more mats at one time.

The mats could be made with a natural color or could be made with pigments or other coloring to produce a desired color, white, black, tan, etc.

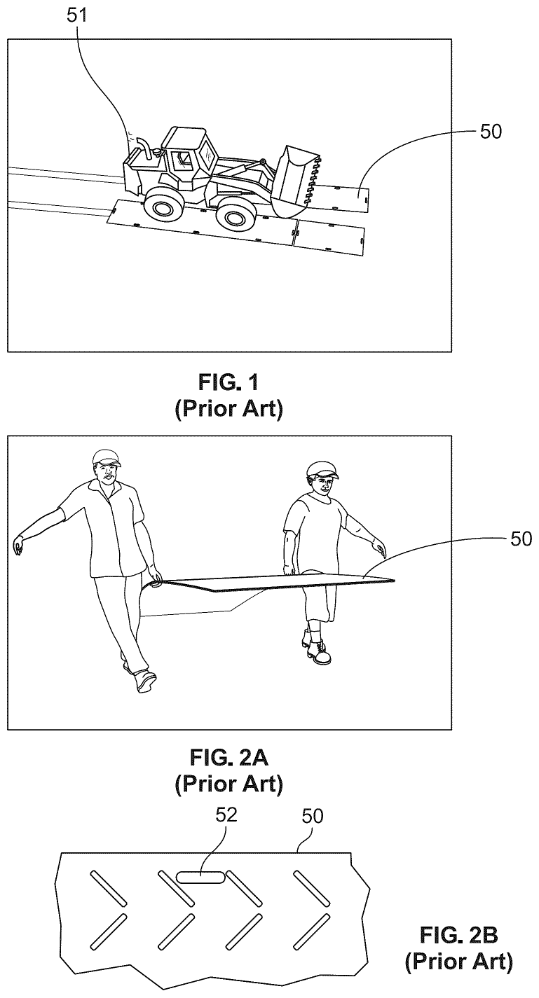

The mat 10 shown in FIG. 3 can be effectively used as a ground protection mat, one is more easily moved to a desired location while still providing the needed properties for carrying purposes and ground protection purposes when heavy equipment would travel over a number of mats when placed in a desired location. The method would entail providing the mats and then placing the mats in a desired location so that any heavy equipment to be used would contact the mats rather than the ground beneath the mats. Depending on the size of the equipment, a series of mats could be placed end to end to create the necessary path for the heavy equipment to travel over ground in a protected manner. In other mode, parallel tracks of mats could be used so that each track of mats would provide the necessary ground protection for equipment whose wheel span would be greater than the width or length of the mat, e.g., a front end loader, see for example, FIG. 1.

Once the mats are positioned in the desired locations for ground protection, heavy equipment can travel over the mat to access the location that the heavy equipment needs to be used. Examples of ground that need protection include lawns, athletic fields, golf courses, parks, and other open areas used for entertainment. However, any kind of ground can be protected through the use of the inventive mats.

Another advantage that the mats offer besides a much lower weight without a loss of the necessary properties like stiffness and the capability to remain integral and stable even under the weight of heavy equipment, is price. It is believed that the foamed polypropylene or ethylene vinyl acetate is significantly lower in cost per unit mat as compared to the prior art mat material. Thus, a person in need of mats for ground protection sees a significant cost savings without a loss in performance of the mats in terms of transportation and use.

While the size of the mat can vary, and particularly depending on the ground intended for protection, lengths of the mats are preferably 8 feet but can be less than 8 feet or even more than 8 feet, e.g., 6 to 9 or 10 feet. The advantage of making a 4×8 or 4×6 foot mat is its light weight in combination with 32 or 24 square feet of area for ground protection. Widths can range from 2 to 6 feet and even encompass up to 8 feet to create a square mat rather than one that is rectangular. A rectangular configuration of the mat is most advantageous as it provides the optimum in ground protection for heavy equipment as the track needed for ground protection may be long and the need in these situations is longer mats not wide mats. Also, mats with longer lengths, e.g., 8 feet lengths, are more preferred since they offer a larger area of protection and require a lesser number of mats for a particular ground protection task.

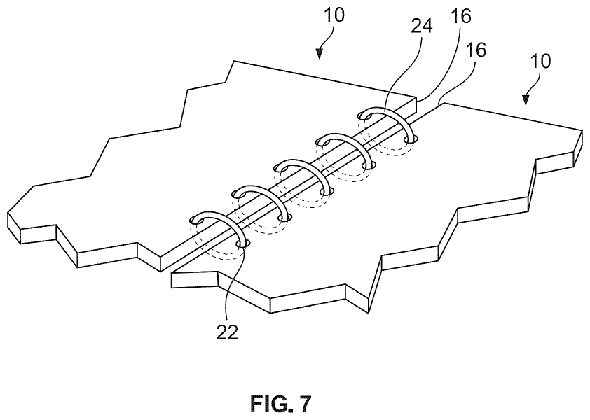

The mats could also employ means to connect mats together in an end to end configuration. For example, a hinge mechanism could be used to connect ends of two adjacent mats together. The hinge mechanism could be linked to the mat using the through openings or integrated into the mat in other ways. Such a hinge mechanism is shown in FIG. 7, wherein the ends 16 of two adjacent mats 10 have a series of openings 22 along the end length and rings 24 are used to connect the adjacent ends of the mat together, much like pages in a binder. You could have 5 mats connected and stored in an accordion-like fashion and then unfolded when the mats are to be positioned in a location. Other mechanisms could be used as well, e.g., flexible members like rope that would tie the two adjacent mats together while still letting the mats fold with respect to each other.

As such, an invention has been disclosed in terms of preferred embodiments thereof which fulfills each and every one of the objects of the present invention as set forth above and provides a new and improved ground protection mat and method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A ground protection mat comprising a sheet of material, the sheet of material having side edges and end edges, the sheet of material made from a foamed polymeric material, preferably either a foamed polypropylene or a foamed ethylene vinyl acetate, the sheet material having at least a 0.75 inch thickness, the sheet material including means for attaching the sheet material to ground for ground protection purposes.

2. The mat of claim 1, wherein the sheet material has top and bottom surfaces, and one or both of the top and bottom surfaces includes a plurality of raised portions extending from the top and/or bottom surface to provide traction for any equipment contacting the ground protection mat.

3. The mat of claim 1, further comprising a plurality of mat-carrying slots, the plurality of mat-carrying slots arranged near either or both of the side and/or end edges.

4. The mat of claim 1, wherein the sheet of material is the foamed ethylene vinyl acetate.

5. The mat of claim 1, wherein the sheet of material is the foamed polypropylene.

6. The mat of claim 1, wherein the foamed polymeric material has a flexural strength of between about 2400 and about 6000 kpa.

7. The mat of claim 1, wherein the foamed ethylene vinyl acetate has a flexural strength of between about 2400 and about 6000 kpa.

8. The mat of claim 1, wherein the mat has a size ranging from 2 to 6 feet in width and 6-9 feet in length, preferably 8 feet in length.

9. The mat of claim 1, wherein the attaching means includes through openings in the mat in spaced apart locations, preferable locations near corners of the mat.

10. The mat of claim 1, further comprising means for connecting or attaching opposing ends of adjacent mats together.

11. A method of protecting ground from damage due to undue weight placed thereon comprising:
providing a plurality of mats according to claim 1; and
placing the plurality of mats on ground in need of protection.

12. The method of claim 11, wherein the mats are placed end to end to create at least one track for ground protection.

13. The method of claim 12, wherein two tracks of end to end mats are created.

14. The method of claim 11, wherein the mats are attached to the ground.

15. The method of claim 11, further comprising driving heavy equipment on the plurality of mats.

16. The method of claim 11, wherein the placing step includes one person carrying at least one mat, preferably two mats.

17. The method of claim 11, wherein the mats are provided in a folded state in a stored portion and unfolded for the placing step.
